(19) United States
(12) Patent Application Publication
(10) Pub. No.: US 2011/0203155 A1
(43) Pub. Date: Aug. 25, 2011

(54) FISH CATCHER ROD HOLDER

(76) Inventor: Jessie Simmons, Odenville, AL (US)

(21) Appl. No.: 12/712,171

(22) Filed: Feb. 24, 2010

(51) Int. Cl. A01K 97/12; A01K 97/10

(52) U.S. Cl. 43/17; 43/21.2

(57) ABSTRACT

The present invention solves several problems of the existing fishing rod holder systems by employing a fishing rod holder design which makes the rod holder structurally robust, fully and easily adjustable, and totally conducive to the setting of the hook right out of the rod holder. Furthermore, the present invention employs a t-bar design which makes the t-bar system strong, easy to transport and store, and more importantly, fully adaptable from a boat or pier fishing to bank fishing. In addition, the present invention, replaces the bobber with a more practical, more efficient and easier to use visual tool, the strike indicator.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

The present invention relates generally to fishing.

2. Description of the Related Art

With most of the fishing rod holders currently on the market, you have to take the rod out to set the hook. Also, most of the existing fishing rod holders come in fixed position or with limited, or difficult to set, adjustability. Furthermore, the existing fishing rod holders and their accompanying t-bar systems are either weak structurally, difficult to transport and store, or inadaptable to bank fishing. Moreover, the bobber system, which is currently widely used by fishermen, is not practical and efficient enough for less experienced fishermen or for kids learning how to fish.

### BRIEF SUMMARY OF THE INVENTION

The present invention solves the above enumerated problems by employing a fishing rod holder design which makes the rod holder structurally robust, fully and easily adjustable, and totally conducive to the setting of the hook right out of the rod holder. Furthermore, the present invention employs a t-bar design which makes the t-bar system strong, easy to transport and store, and more importantly, fully adaptable from a boat or pier fishing to bank fishing. In addition, the present invention, replaces the bobber with a more practical, more efficient and easier to use visual tool, the strike indicator.

### BRIEF DESCRIPTION OF THE DRAWINGS

For exemplification purposes, and not for limitation purposes, embodiments of the invention are illustrated in the figures of the accompanying drawings, in which:

FIG. 1 illustrates the perspective view of a prior art (Driftmasters) t-bar system with a base mounting plate welded 14 to the one piece t-bar 13, the narrow and enclosed rear loop of the fishing rod holder 12, and the difficult to access wing nut 11.

FIG. 2 illustrates the perspective view of a prior art (Driftmasters) fishing rod holder with the boat or pier mounting plate 21.

FIG. 3 illustrates the perspective view of a prior art (Titelok) t-bar system with a base mounting plate 32 welded to the t-bar, and a structurally week horizontal element 31 of the t-bar.

FIG. 4 illustrates the exploded view of the present invention's t-bar system in accordance with several embodiments of the present invention. FIG. 4 shows the wrench like handle 41, fishing rod holder 42, t-bar top plate (i.e., the horizontal element of the t-bar) 43, bolt 44, t-bar mounting plate 45, washer 46, wing nut 47, ½ in bolt (i.e., vertical element of the t-bar) 48, thread 49 at the lower end of the bolt 48, ½ in wing nut 410, base mounting plate 411 with holes 412 and nut 413.

FIG. 5 illustrates the front view of the fishing rod holder with its front cradle 51, rear loop 52, and its cylindrical base 53 which has the opening 54, in accordance with an embodiment of the present invention.

FIG. 6 illustrates the side view of the fishing rod holder with its front cradle 61, rear loop 62, and its cylindrical base 63 which has the opening 64, in accordance with an embodiment of the present invention.

FIG. 7 illustrates the perspective view of the rod holder cylindrical base 71 with its opening 72, together with bolt 73, washer 74 and wrench like handle 75, in accordance with an embodiment of the present invention.

FIG. 8 illustrates the side view of the lower and threaded end 82 of bolt 81 being screwed in the hex nut 84, secured with the wing nut 83, while the hex nut 84 is welded in the bank stake 85, in accordance with an embodiment of the present invention.

FIG. 9 illustrates the perspective view of rod holder assembly set for bank fishing, in accordance with several embodiments of the present invention. FIG. 9 shows strike indicator ball 91, strike indicator wire 92, rod holder 93, strike indicator mounting screw 94, rod holder cylindrical base 95 with its opening 96, bolt-wing nut assembly 97 and its detail view 98, and bank fishing stake 99.

FIG. 10 illustrates the perspective view of an actual strike indicator with its ball element 101, wire element 102 and mounting screw 103, in accordance with an embodiment of the present invention.

FIG. 11 illustrates a closer perspective view of the strike indicator's mounting screw 111, in accordance with an embodiment of the present invention.

FIG. 12 illustrates the perspective view of an actual bank fishing assembly in which 121 is the strike indicator, 122 is the fishing line, 123 is the rod handle, and 124 is the cylindrical rod holder base with its opening 125, in accordance with several embodiments of the present invention.

FIG. 13 illustrates the perspective view of an actual two rod holder t-bar system mounted on a pier by screwing bolt 131 into the mounting plate 132 and being secured with the wing nut 133, in accordance with several embodiments of the present invention.

FIG. 14 illustrates the location of magnet 141 in a two rod holder t-bar system, in accordance with an embodiment of the present invention.

FIG. 15 illustrates the perspective view of an actual two rod holder t-bar system mounted on a bank stake 154 by screwing bolt 151 into the bank stake's hex nut 153 and being secured with the wing nut 152, in accordance with several embodiments of the present invention.

FIG. 16 illustrates the top view of an actual four rod holder t-bar system mounted on a pier in accordance with several embodiments of the present invention. In this figure, 161 shows different objects (knife, pliers, etc) attached to the t-bar system by two magnets.

FIG. 17 illustrates the location of magnets 171 in a four rod holder t-bar system, in accordance with an embodiment of the present invention.

### DETAILED DESCRIPTION OF THE INVENTION

What follows is a detailed description of specific embodiments of the invention in which the invention may be practiced. Reference will be made to the attached drawings, and the information included in the drawings is part of this detailed description. The specific embodiments of the invention, which will be described herein, are presented for exemplification purposes, and not for limitation purposes. It should be understood that structural and/or logical modifications could be made by someone of ordinary skills in the art without departing from the scope of the present invention. Therefore, the scope of the present invention is defined only by the accompanying claims and their equivalents.

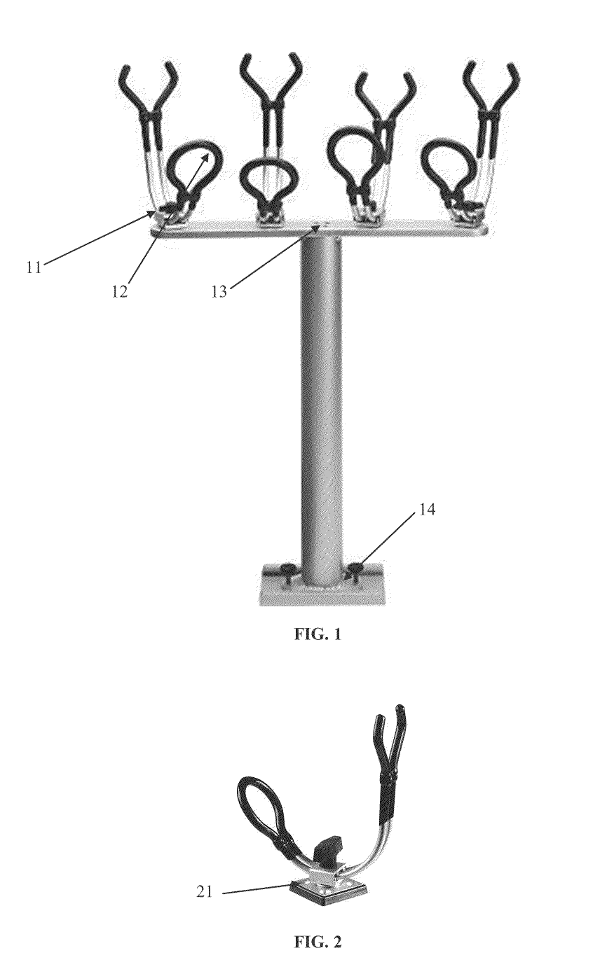

FIG. 1 illustrates the perspective view of a prior art (Driftmasters) t-bar system with a base mounting plate 14 welded to the one-piece t-bar 13, the narrow and enclosed rear loop of the fishing rod holder 12, and the difficult to access wing nut 11. Unlike the t-bar system of the present invention, this t-bar system has the base 14 welded to the t-bar. This design makes this-bar system usable only on a pier or a boat and not on a bank. The one-piece design, with the horizontal element and the vertical element being welded together 13, makes the transport and storage of this t-bar system considerably difficult. The wing nut 11 design and location makes the wing nut 11 difficult to access when the fishing rod is on the rod holder, hence impeding upon an easy and quick adjustment of the rod holder's orientation. In addition, the narrow and enclosed rear loop of this fishing rod holder 12 makes this rod holder totally non-conducive to the setting of the hook right out of the rod holder.

FIG. 2 illustrates the perspective view of a prior art (Driftmasters) fishing rod holder with the boat or pier mounting plate 21. This design, with only an irreplaceable mounting plate for pier or both fishing, also makes this rod holder unusable for bank fishing.

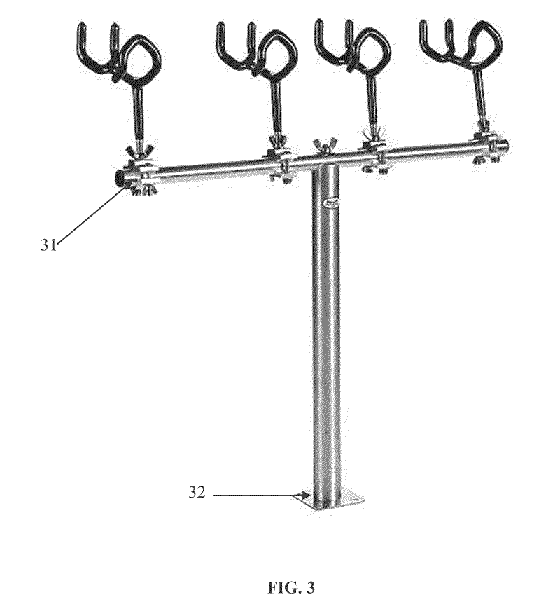

FIG. 3 illustrates the perspective view of a prior art (Titelok) t-bar system with a base mounting plate 32 welded to the t-bar, and a structurally week horizontal element 31 of the t-bar. Because of the relatively weak design of the horizontal element 31 of this t-bar system, the rod holder rotates when the fish pulls on the fishing line. In addition, because the mounting plate 32 is welded to the t-bar, this t-bar system also is unusable for bank fishing.

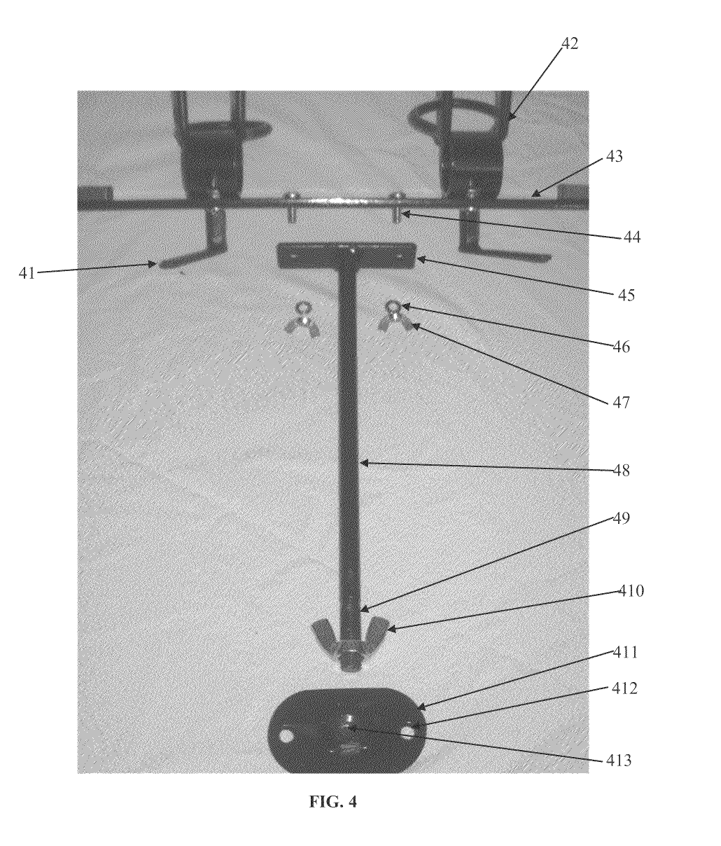

FIG. 4 illustrates the exploded view of the present invention's t-bar system in accordance with several embodiments of the present invention. FIG. 4 shows the wrench like handle 41, fishing rod holder 42, t-bar top plate (i.e., the horizontal element of the t-bar) 43, bolt 44, t-bar mounting plate 45, washer 46, wing nut 47, ½ in bolt (i.e., vertical element of the t-bar) 48, thread 49 at the lower end of the bolt 48, ½ in wing nut 410, base mounting plate 411 with holes 412 and nut 413. Except for the magnets, the t-bar system is made preferably from stainless steel. Other materials with similar physical characteristics may be used. The wrench-like handle 41 has a nut welded to it and it is used to quickly and easily adjust the orientation of the rod holder 42. The unique design and the location of the wrench-like handle 41, under the horizontal element 43, makes the adjusting of the orientation of the rod holder particularly convenient and fast, by allowing for a quick release and quick fastening of the rod holder 42 to the t-bar top plate 43. The wrench-like handle 41 is ½ inch wide, 3½ inches long with a 5/16×1 inch nut welded to one end. The handle 41 can be coated with rubber or other similar materials in order to make it more comfortable to use and easier to grip.

The bolt 48 is preferably 12 inches in length and ½ inch in diameter, and it has the upper end (i.e., the bolt's head) welded onto the mounting plate 45. The assembly created by the mounting plate 45 and the bolt 48 is attached to the t-bar top plate 43 using two Phillips bolts ¼×¾ inches long 44, and for each bolt 44, a corresponding washer 46 and a corresponding wing nut 47. The top plate 43 is approximately ¼ inch thick, 1 inch wide, and 12 inches long for the 2-rod holder system and 24 inches for the 4-rod holder system. This design creates a t-bar system which is strong and easy to transport and store: the joint between the horizontal element, the top plate 43, and the vertical element, the bolt 48, is in the same time strong and undoable in seconds.

The base mounting plate 411 is preferably three inches long, two inches wide and ⅛ inch thick, and it has a ¾ inch 413 nut welded in its center. The two holes 412 on each end of the base mounting plate 411 allows for its attachment, by using two screws, onto a pier or boat. The bolt 48 is attached to the base mounting plate 411 by screwing the bolt into nut 413 and then securing the new joint with the wing nut 410. This design allows the fisherman to leave the base mounting plate attached to the pier or boat for a later use, and to use the t-bar system for bank fishing as explained lower in this document.

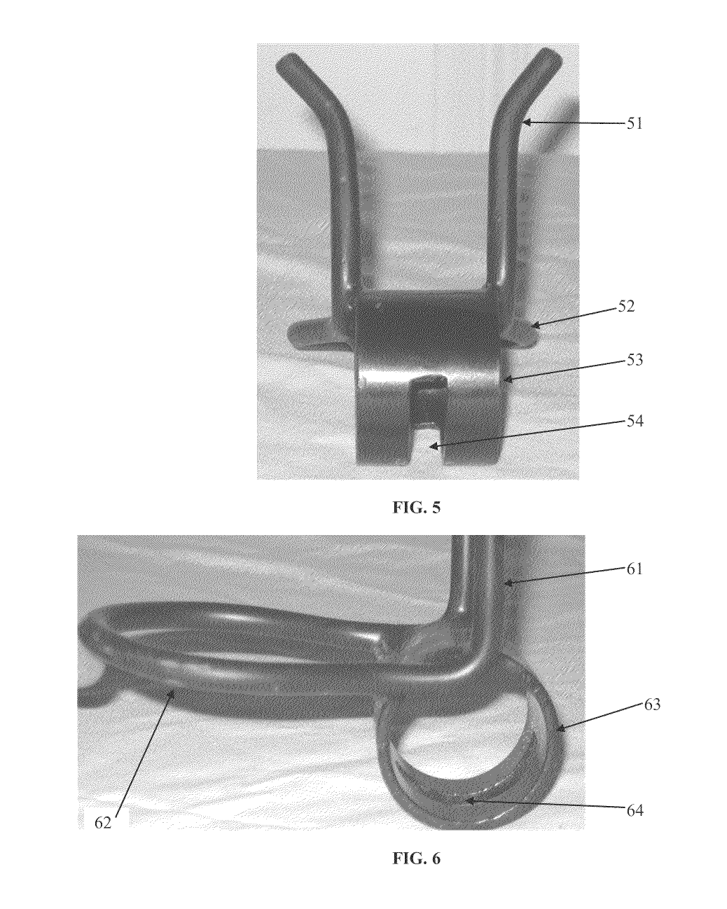

FIG. 5 illustrates the front view of the fishing rod holder with its front cradle 51, rear loop 52, and its cylindrical base 53 which has the opening 54, in accordance with an embodiment of the present invention. FIG. 6 illustrates the side view of the fishing rod holder with its front cradle 61, rear loop 62, and its cylindrical base 63 which has the opening 64, in accordance with an embodiment of the present invention. The rod holder 61 may be made of ¼ inch, or more, round steel. The rod holder's unique design, characterized by the bent away ends of the front cradle 51, the relatively large rear loop 62, and its cylindrical base 63, makes possible the setting of the hook, with ease, and right out of the rod holder. The cylindrical base 63 is approximately 2 inches in outside diameter, 1½ inches long with a 3/16 inch wall thickness. The opening 64 of the cylindrical base 63 is 5/16×2½ inches long and allows for the easy adjustment of the orientation of the rod holder in both directions, horizontally or left-right, and vertically or up-down.

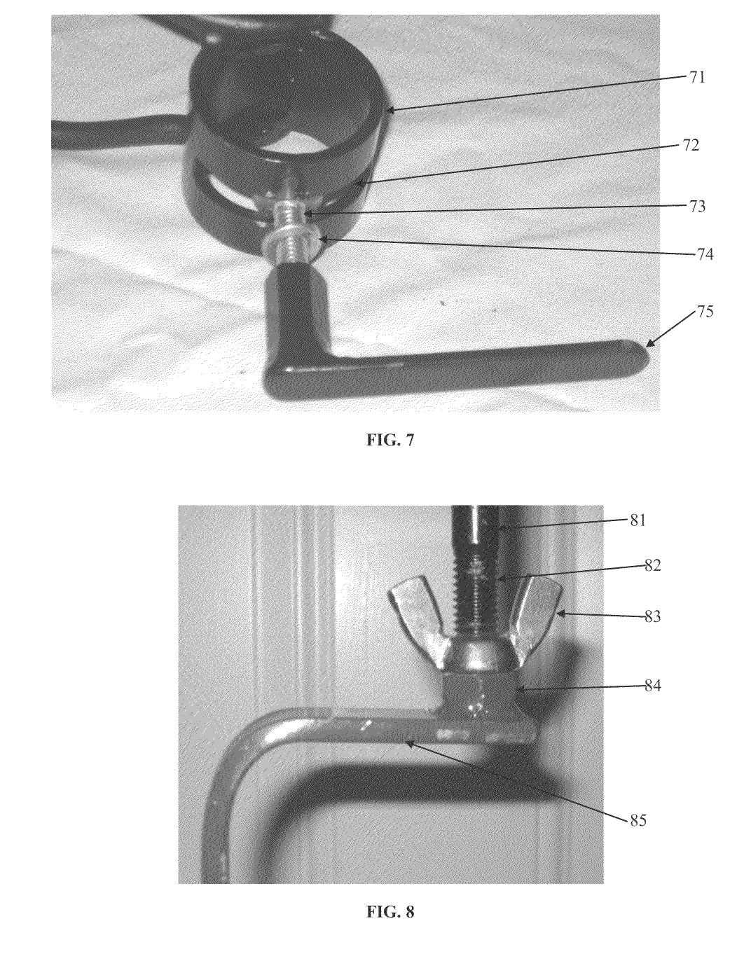

FIG. 7 illustrates the perspective view of the rod holder cylindrical base 71 with its opening 72, together with bolt 73, washer 74 and wrench like handle 75, in accordance with an embodiment of the present invention. The size of bolt 73 is preferably 5/16 inch by 1¼ inches. The wrench-like handle 75 has a nut of size 5/16 by 1 inch welded onto it. The wrench-like handle 75 is preferably 3½ inches long.

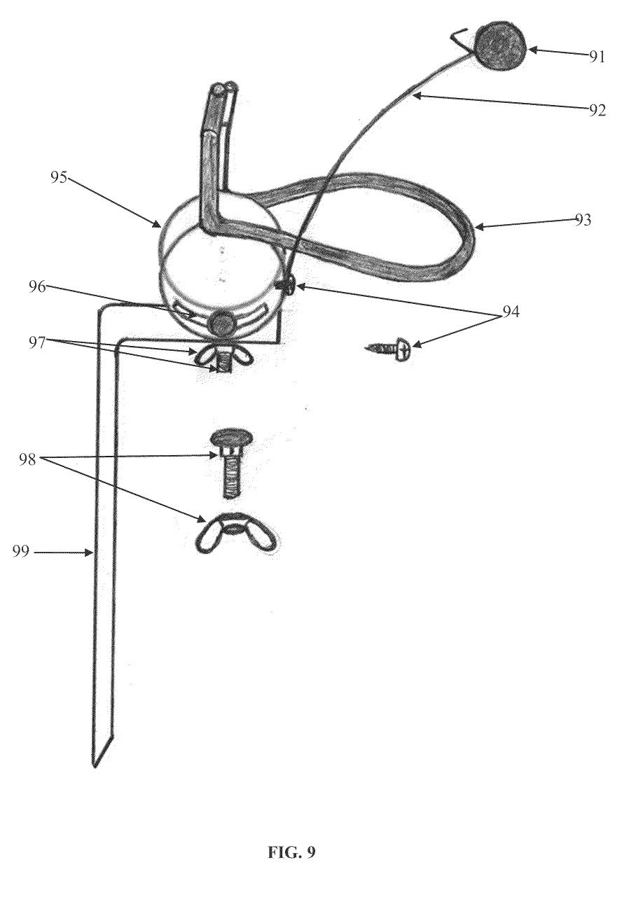

FIG. 8 illustrates the side view of the lower and threaded end 82 of bolt 81 being screwed in the hex nut 84, secured with the wing nut 83, while the hex nut 84 is welded onto the bank stake 85, in accordance with an embodiment of the present invention. The bank stake 85 is made out of flat steel, ¼ in thick, two inches wide, and approximately 19½ inches long. One of ordinary skills in the art would recognized that these dimensions, as well as the other dimensions specified in this disclosure, are given for exemplification purposes only, and that variations of these dimensions may be used without departing from the scope of the present invention. The hex nut 84 is welded onto the bank stake 85 and has the same size, ¾ inch, as the hex nut 41 from FIG. 4. Again, this allows for the use of the same t-bar system with the base mounting plate 411 (FIG. 4) for pier or boat fishing, as well as, with the bank stake 85 for bank fishing.

FIG. 9 illustrates the perspective view of a rod holder assembly set for bank fishing, in accordance with several embodiments of the present invention. FIG. 9 shows strike indicator ball 91, strike indicator wire 92, rod holder 93, strike indicator mounting screw 94, rod holder cylindrical base 95 with its opening 96, bolt-wing nut assembly 97 and its detail view 98, and bank fishing stake 99. The strike indicator can be used for bank, pier or boat fishing. The strike indicator's wire 92 is made of an elastic material, preferably 0.028 inch spring steel wire. Other materials with similar physical characteristics may be used. One of ordinary skills in the art would recognize that the thickness of the wire may vary according to the conditions under which fishing occurs. For example, thicker wire may be needed in turbulent water and thinner wire may be needed in calmer water.

The strike indicator's ball 91 is made from a light-weight material like Styrofoam and it can be colored in yellow, orange or any other color that makes it easily observable by the fisherman. The ball 91 is preferably 1 inch in diameter, and may be attached to the wire 92 by pressing it into a small loop made in the wire 92. One of ordinary skills in the art would recognize that the ball 91 may be substituted with any other object of various shapes, color, or material, which may fulfill a similar visual function. The strike indicator's wire 92 is secured to the rod holder's 93 cylindrical base 95 by the use of a self tapping screw 94 and an appropriate hole in the cylindrical base 95. One of ordinary skills in the art would recognize that the wire 92 may be attached to other parts or elements of the t-bar and/or fishing rod, reel, or rod holder, and obtain similar results, hence, without departing from the scope of the present invention. The rod holder 93 and its cylindrical base 95 is attached to the bank stake 99 by employing the bolt-wing nut assembly 97 and a corresponding hole in the bank stake 99.

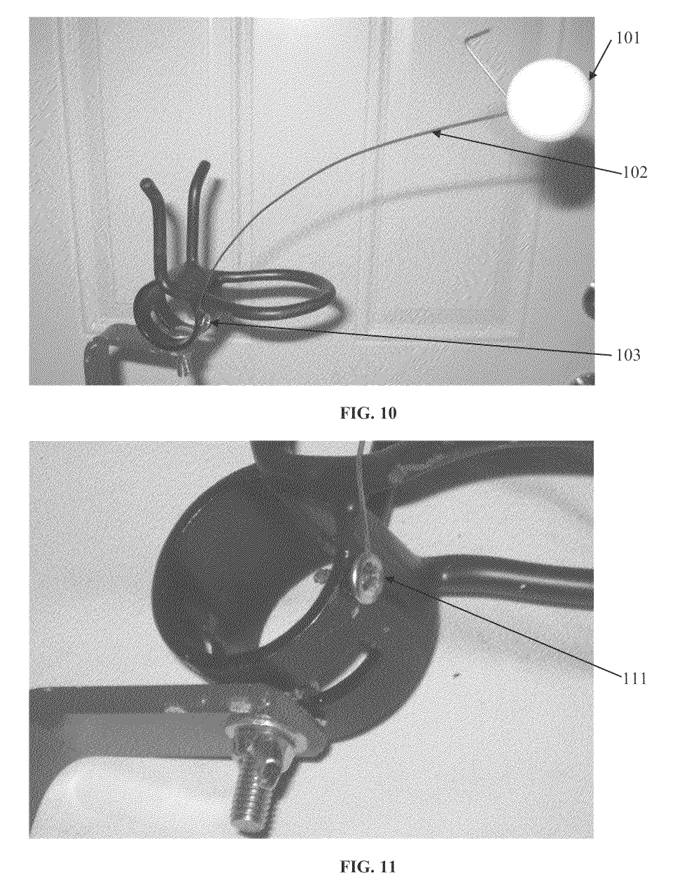

FIG. 10 illustrates the perspective view of an actual strike indicator with its ball element 101, wire element 102 and mounting screw 103, in accordance with an embodiment of the present invention.

FIG. 11 illustrates a closer perspective view of the strike indicator's mounting screw 111, in accordance with an embodiment of the present invention.

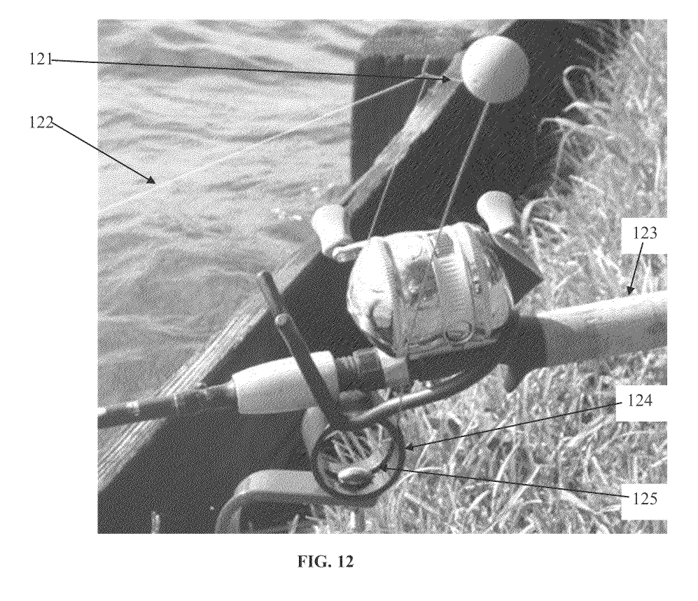

FIG. 12 illustrates the perspective view of an actual bank fishing assembly in which 121 is the strike indicator, 122 is the fishing line, 123 is the rod handle, and 124 is the cylindrical rod holder base with its opening 125, in accordance with several embodiments of the present invention. The strike indicator 121 works as follows: the line 122 has to be placed on the strike indicator 121 in neutral position as shown. When fish pulls the strike indicator approximately 8 to 10 inches, set the hook and reel in. When the hook is set, the line will be automatically released by the strike indicator. The strike indicator 121 is a better visual tool than a bobber because of its close proximity to fisherman which makes it easier to observe and determine with higher accuracy the right moment for setting the hook. This advantage of the strike indicator is of particular benefit to less experienced fishermen and children learning how to fish. Furthermore, as explained earlier, the unique design of the rod holder makes possible the setting of the hook right out of the rod holder.

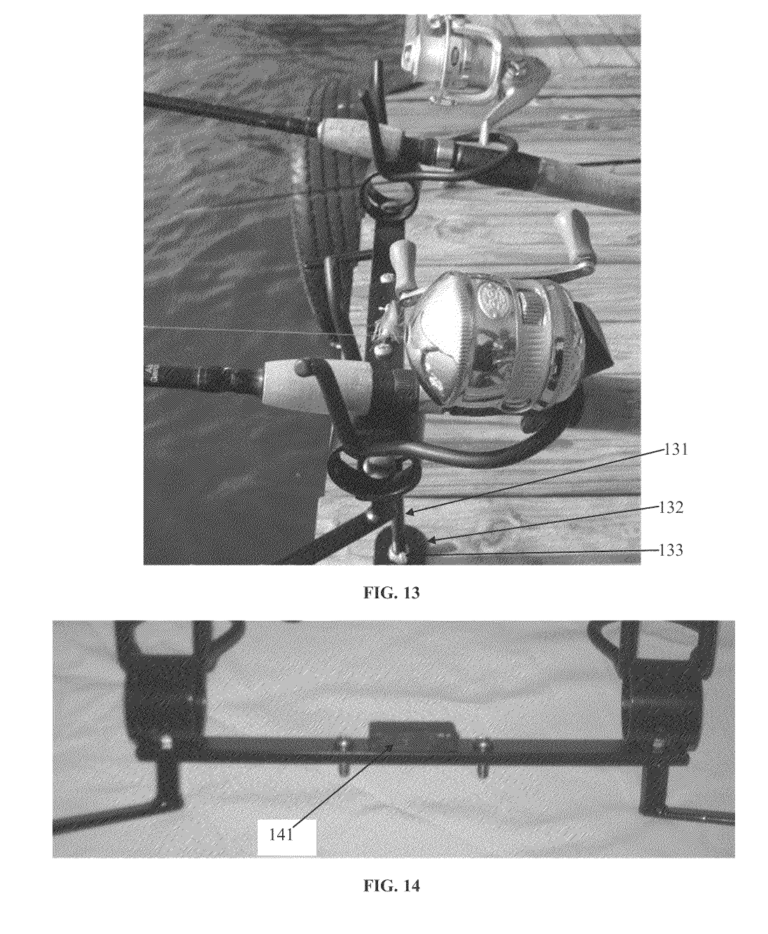

FIG. 13 illustrates the perspective view of an actual two rod holder t-bar system mounted on a pier by screwing bolt 131 into the mounting plate 132 and being secured with the wing nut 133, in accordance with several embodiments of the present invention.

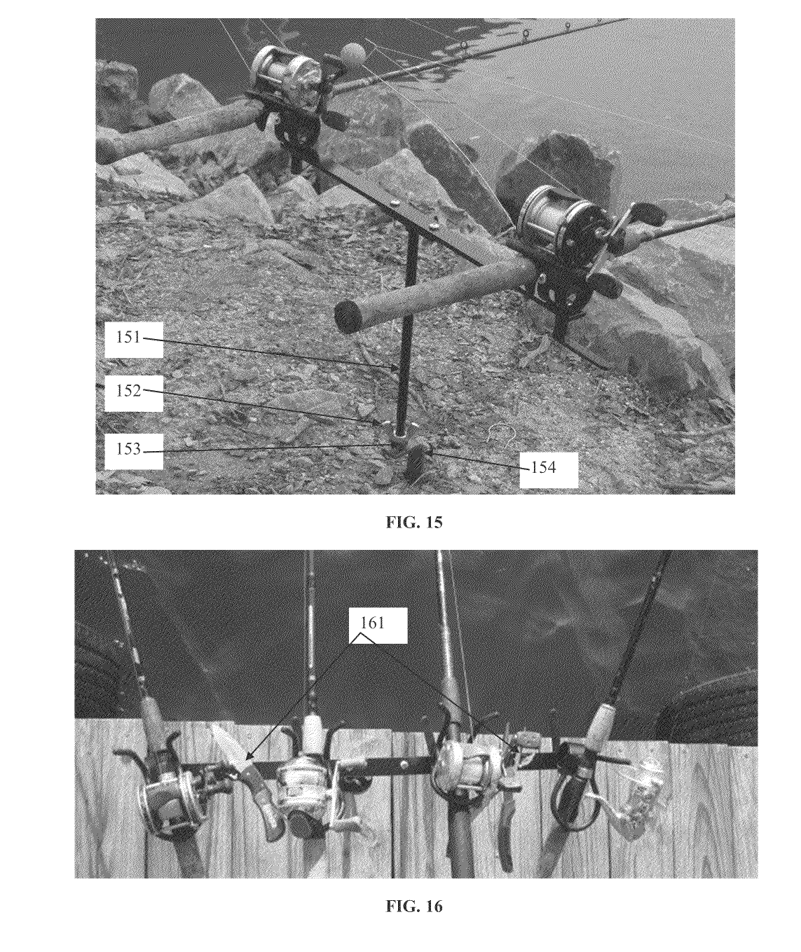

FIG. 14 illustrates the location of magnet 141 in a two rod holder t-bar system, in accordance with an embodiment of the present invention. The magnet size is preferably 2 inches long, 1 inch wide and ⅜ thick. The magnet 141 is attached to the t-bar system using generic glue for metals. The magnet 141 is used to attach to the t-bar system jigs, pliers, hooks, line cutters or any other tools or objects the fisherman may need to access quickly and/or easily.

FIG. 15 illustrates the perspective view of an actual two rod holder t-bar system mounted on a bank stake 154 by screwing bolt 151 into the bank stake's hex nut 153 and being secured with the wing nut 152, in accordance with several embodiments of the present invention.

FIG. 16 illustrates the top view of an actual four rod holder t-bar system mounted on a pier in accordance with several embodiments of the present invention. In this figure, 161 shows different objects (knife, pliers, etc) attached to the t-bar system by two magnets.

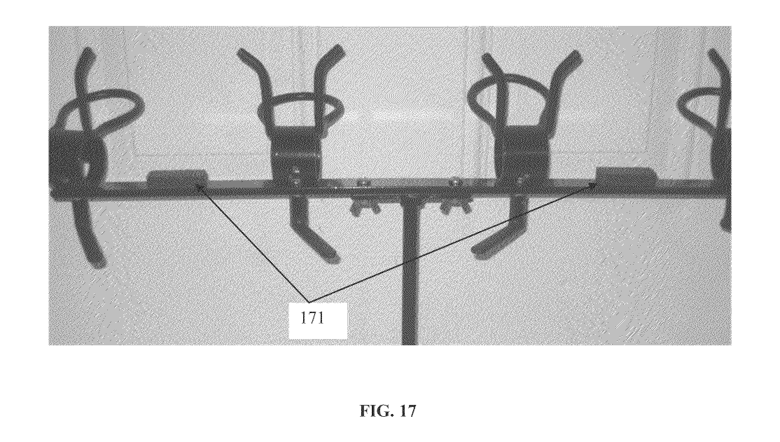

FIG. 17 illustrates the location of magnets 171 in a four rod holder t-bar system, in accordance with an embodiment of the present invention.

Although specific embodiments have been illustrated and described herein for the purpose of disclosing the preferred embodiments, someone of ordinary skills in the art will easily detect alternate embodiments and/or equivalent variations, which may be capable of achieving the same results, and which may be substituted for the specific embodiments illustrated and described herein without departing from the scope of the present invention. Therefore, the scope of this application is intended to cover alternate embodiments and/or equivalent variations of the specific embodiments illustrated and/or described herein. Hence, the scope of the present invention is defined only by the accompanying claims and their equivalents.

What is claimed is:

1. A strike indicator comprising an elastic wire and a light-weight ball.

2. A strike indicator as in claim 1, wherein said elastic wire has one of its ends attached to the rod holder's base.

3. A strike indicator as in claim 1, wherein said elastic wire is made of a metallic material.

4. A rod holder having a cylindrical base with an opening in it, which makes the rod holder's orientation changeable horizontally and vertically.

5. A rod holder as in claim 4, wherein said rod holder's shape allows the setting of the hook right out of the said rod holder.

6. A rod holder as in claim 4, wherein said rod holder's orientation is changed using a wrench-like handle.

7. A t-bar system having a vertical element and a horizontal element and being capable of use for pier, boat and bank fishing.

8. A t-bar system as in claim 7, wherein said vertical element has its lower end threaded.

9. A t-bar system as in claim 7 further capable of having the said vertical element manually separated from said horizontal element.

10. A t-bar system as in claim 7 with one magnet attached to it.

11. A t-bar system as in claim 7 with two magnets attached to it.
